(19) United States
(12) Patent Application Publication
(10) Pub. No.: US 2024/0033744 A1
(43) Pub. Date: Feb. 1, 2024

(54) ASSEMBLY FOR FORMING A SEALED CHAMBER

(71) Applicant: 10x Genomics, Inc., Pleasanton, CA (US)

(72) Inventors: David Morgan, Castro Valley, CA (US); Denis Pristinski, Dublin, CA (US); Evan Dejarnette, San Francisco, CA (US); Joshua Cataldo, Oakland, CA (US); Yiran Zhang, Castro Valley, CA (US); Zhenping Guan, Pleasanton, CA (US); Adrian Tanner, Oakland, CA (US); Lila Haba, San Francisco, CA (US); Brenden Janatpour Brown, Castro Valley, CA (US); Francis Cui, Oakland, CA (US)

(73) Assignee: 10x Genomics, Inc., Pleasanton, CA (US)

(21) Appl. No.: 18/328,295

(22) Filed: Jun. 2, 2023

Related U.S. Application Data
(60) Provisional application No. 63/348,879, filed on Jun. 3, 2022.
(60) Provisional application No. 63/425,914, filed on Nov. 16, 2022.

(51) Int. Cl. B01L 9/00

(52) U.S. Cl. CPC B01L 9/52; B01L 2200/0689; B01L 2300/0809; B01L 2200/025

(57) ABSTRACT

Various embodiments of the present disclosure disclose a system for forming a sealed chamber for preparing samples therein. In particular, various embodiments present an assembly that includes a sample device and a lid for forming a sealed chamber that can be used for, among other things, incubating samples therein. When the lid engages with the sample device, a plurality of snap joint elements of the lid engage with a respective plurality of snap joint elements to form a seal between the lid and the sample device.

CROSS-REFERENCE

The present application is a non-provisional of 63/348,879, filed Jun. 3, 2022, entitled “METHODS, SYSTEMS, AND DEVICES FOR SAMPLE INTERFACE,” and 63/425,914, filed Nov. 16, 2022, entitled “ASSEMBLY FOR FORMING A SEALED CHAMBER” which applications are herein incorporated by reference in their entirety for all purposes.

### FIELDS OF THE DISCLOSURE

The present disclosure is directed to assemblies for forming a sealed chamber for preparing samples therein. In particular, the present disclosure describes an assembly of a sample device and a lid for forming a sealed chamber that can be used for, among other things, incubating samples therein.

### BACKGROUND

Existing solutions for sealing a well to form a sealed chamber utilize a sealing tape or other cover, and place the same over an opening of the well. In most cases, the tape or cover is placed flush with the opening of the well. This is to reduce the space between the sample and the tape, so that heat can be delivered to the sample efficiently when delivered via the tape. For instance, when heat is delivered to a sample (e.g., in the presence of a fluid) via a heated thermal cycler lid that is contact or flush with the tape, then the heat may be delivered to the sample more efficiently when the space between the sample and the tape is low. This, however, may not be desirable because a disturbance to the sample or well can result in the formation of a fluid capillary bridge between the top surface of the bottom of the well and the tape. For example, a fluid that is in the well may wick up and form a bridge, with undesirable consequences such as but not limited to the de-wetting of the sample/well, leaking, etc. Accordingly, there exists a need for a system for forming a sealed chamber that address at least the identified deficiencies.

### SUMMARY

Various embodiments of the present disclosure disclose a system for forming a sealed chamber for preparing samples therein. For example, the sample can be an assembly that comprises a sample device and a lid for covering the sample device. In various embodiments, the sample device includes a bottom portion and a top portion. In some instances, the bottom portion is releasably coupled to the top portion. Further, a gap is formed between the bottom portion and the top portion when the bottom portion is coupled to the top portion, where the gap is configured to receive a sample substrate. In addition, the top portion includes a well and a plurality of first snap joint elements, where at least a pair of the plurality of first snap joint elements are arranged on the top portion substantially opposite from each other. The lid includes a lid cover and a skirt. In some instances, the cover includes a planar outer surface; and an inner surface separated from the planar outer surface by a thickness of the cover. In some instances, the skirt extends about a perimeter of the inner surface. Further, the skirt and the inner surface define a recess. In addition, the skirt includes a plurality of second snap joint elements extending therefrom, where at least a pair of the plurality of second snap joint elements are arranged on the skirt substantially opposite from each other. In some instances, when the lid is engaged with the sample device, the plurality of second snap joint elements engage with the plurality of second snap joint elements respectively to form a seal between the lid and a periphery of the well of the top portion.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 is an example workflow of analysis of a biological sample (e.g., a cell or tissue sample) using an opto-fluidic instrument, according to various embodiments.

FIG. 2 illustrates a sample device including a sample well defined by a substrate and a gasket, according to various embodiments.

FIGS. 3A-3C illustrate bridging in a sample device sealed with a tape, according to various embodiments.

FIGS. 4A and 4B illustrate top and bottom views of a lid for covering the sample device, according to various embodiments.

FIGS. 4C and 4D illustrate cross-sectional and partial views of a lid for covering the sample device, according to various embodiments.

FIGS. 5A-5D illustrate engagement of the lid with the sample device (FIGS. 5A-5C), including in the presence of a thermal cycling lid (FIG. 5D), according to various embodiments.

FIG. 6 illustrates a cross-sectional view of a lid, according to various embodiments.

FIGS. 7A-7H illustrate a gasket for a sample device, according to various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

### I. Overview

Target molecules (e.g., nucleic acids, proteins, antibodies, etc.) can be detected in biological samples (e.g., one or more cells or a tissue sample) using an instrument having integrated optics and fluidics modules (an “opto-fluidic instrument” or “opto-fluidic system”). In an opto-fluidic instrument, the fluidics module is configured to deliver one or more reagents (e.g., fluorescent probes) to the biological sample and/or remove spent reagents therefrom. Additionally, the optics module is configured to illuminate the biological sample with light having one or more spectral emission curves (over a range of wavelengths) and subsequently capture one or more images of emitted light signals from the biological sample during one or more probing cycles. In various embodiments, the captured images may be processed in real time and/or at a later time to determine the presence of the one or more target molecules in the biological sample, as well as three-dimensional position information associated with each detected target molecule. Additionally, the opto-fluidics instrument includes a sample module configured to receive (and, optionally, secure) one or more biological samples. In some instances, the sample module includes an X-Y stage configured to move the biological sample along an X-Y plane (e.g., perpendicular to an objective lens of the optics module).

In various embodiments, the opto-fluidic instrument is configured to analyze one or more target molecules in their naturally occurring place (i.e., in situ) within the biological sample. For example, an opto-fluidic instrument may be an in situ analysis system used to analyze a biological sample and detect target molecules including but not limited to DNA, RNA, proteins, antibodies, and/or the like.

A sample disclosed herein can be or be derived from any biological sample. Biological samples may be obtained from any suitable source using any of a variety of techniques including, but not limited to, biopsy, surgery, and laser capture microscopy (LCM), and generally includes cells, tissues, and/or other biological material from the subject. A biological sample can be obtained from a prokaryote such as a bacterium, an archaea, a virus, or a viroid. A biological sample can also be obtained from non-mammalian organisms (e.g., a plant, an insect, an arachnid, a nematode, a fungus, or an amphibian). A biological sample can also be obtained from a eukaryote, such as a tissue sample from a mammal. A biological sample from an organism may comprise one or more other organisms or components therefrom. For example, a mammalian tissue section may comprise a prion, a viroid, a virus, a bacterium, a fungus, or components from other organisms, in addition to mammalian cells and non-cellular tissue components. Subjects from which biological samples can be obtained can be healthy or asymptomatic subjects, subjects that have or are suspected of having a disease (e.g., an individual with a disease such as cancer) or a pre-disposition to a disease, and/or subjects in need of therapy or suspected of needing therapy.

The biological sample can include any number of macromolecules, for example, cellular macromolecules and organelles (e.g., mitochondria and nuclei). The biological sample can be obtained as a tissue sample, such as a tissue section, biopsy, a core biopsy, needle aspirate, or fine needle aspirate. The sample can be a fluid sample, such as a blood sample, urine sample, or saliva sample. The sample can be a skin sample, a colon sample, a cheek swab, a histology sample, a histopathology sample, a plasma or serum sample, a tumor sample, living cells, cultured cells, a clinical sample such as, for example, whole blood or blood-derived products, blood cells, or cultured tissues or cells, including cell suspensions.

In some embodiments, the biological sample may comprise cells or a tissue sample which are deposited on a substrate. As described herein, a substrate can be any support that is insoluble in aqueous liquid and allows for positioning of biological samples, analytes, features, and/or reagents on the support. In some embodiments, a biological sample is attached to a substrate. In some embodiments, the substrate is optically transparent to facilitate analysis on the opto-fluidic instruments disclosed herein. For example, in some instances, the substrate is a glass substrate (e.g., a microscopy slide, cover slip, or other glass substrate). Attachment of the biological sample can be irreversible or reversible, depending upon the nature of the sample and subsequent steps in the analytical method. In certain embodiments, the sample can be attached to the substrate reversibly by applying a suitable polymer coating to the substrate and contacting the sample to the polymer coating. The sample can then be detached from the substrate, e.g., using an organic solvent that at least partially dissolves the polymer coating. Hydrogels are examples of polymers that are suitable for this purpose. In some embodiments, the substrate can be coated or functionalized with one or more substances to facilitate attachment of the sample to the substrate. Suitable substances that can be used to coat or functionalize the substrate include, but are not limited to, lectins, poly-lysine, antibodies, and polysaccharides.

A variety of steps can be performed to prepare or process a biological sample for and/or during an assay using the opto-fluidic instruments disclosed herein. Except where indicated otherwise, the preparative or processing steps described below can generally be combined in any manner and in any order to appropriately prepare or process a particular sample for and/or analysis.

For example, a biological sample can be harvested from a subject (e.g., via surgical biopsy, whole subject sectioning) or grown in vitro on a growth substrate or culture dish as a population of cells and prepared for analysis as a tissue slice or tissue section (e.g., a fresh frozen, fixed frozen, or formalin fixed paraffin embedded (FFPE) tissue section). The thickness of a tissue section typically depends on the method used to prepare the section and the physical characteristics of the tissue, and therefore sections having a wide variety of different thicknesses can be prepared and used.

In some instances, the biological sample is fixed in any of a variety of suitable fixatives to preserve the biological structure of the sample prior to analysis. Exemplary fixatives include formalin, formaldehyde, ethanol, methanol, acetone, paraformaldehyde (PFA)-Triton, and combinations thereof.

In some embodiments, a biological sample can be permeabilized to facilitate transfer of analytes out of the sample, and/or to facilitate transfer of species (such as probes or probes sets) into the sample. In general, a biological sample can be permeabilized by exposing the sample to one or more permeabilizing agents. Suitable agents for this purpose include, but are not limited to, organic solvents (e.g., acetone, ethanol, and methanol), cross-linking agents (e.g., paraformaldehyde), detergents (e.g., saponin, Triton X100™ or Tween-20™), and enzymes (e.g., trypsin, proteases).

In some embodiments, the biological sample is embedded in a polymer and/or crosslinked matrix (e.g., a hydrogel matrix). Embedding the sample in this manner typically involves contacting the biological sample with a hydrogel such that the biological sample becomes surrounded by the hydrogel. For example, the sample (e.g., a tissue section on a substrate, such as a glass substrate) can be embedded by contacting the sample with a suitable polymer material and activating the polymer material to form a hydrogel. In some embodiments, the hydrogel is formed such that the hydrogel is internalized within the biological sample. In some embodiments, the biological sample (including biological analytes) is immobilized in the hydrogel via cross-linking of the polymer material that forms the hydrogel. Cross-linking can be performed chemically and/or photochemically, or alternatively by any other suitable hydrogel-formation method. In some instances, biological molecules (or derivatives thereof) are cross-linked or otherwise covalently attached to the hydrogel. For example, in some embodiments, nucleic acid molecules (or derivatives thereof, such as an amplification product or probe(s) bound to cellular nucleic acid molecule) in a tissue sample are cross-linked or otherwise covalently attached to the hydrogel.

Hydrogels embedded within biological samples can be cleared using any suitable method. For example, electrophoretic tissue clearing methods or surfactant-based (e.g., sodium dodecyl sulfate (SDS)) clearing methods can be used to remove biological macromolecules from the hydrogel-embedded sample.

Tissue clearing is a process of optically resolving a sample or complex biological material, such as whole organs, large tissue, and cellular models, with minimal changes to morphology and without compromising the ability for immunolabeling or fluorescence imaging detection. In various embodiments, refractive index matching is used for obtaining fluorescence images. Mismatching among mediums can cause loss of imaging resolution, as light may need to travel through the sample itself, a mounting media, glass coverslip, oil, and/or a microscope objective. In various embodiments, the amount of variable scattering of light from cellular membranes, lipids, and/or molecules of the specimen is reduced (e.g., minimized) using the various methods described herein. Heterogeneity of scattering among the cellular components may lead to an increase in opaqueness of an image. In various embodiments, a denser makeup of lipids, trafficking organelles, and other subcellular molecules may increase lateral, or non-forward, light scattered. In various embodiments, non-forward light scattering in situ may not pass through the specimen, as it is exacerbated by the continuous, pinball like, interactions of scattered light with neighboring molecules. In various embodiments, through the multiplicity of scattering, refraction, and absorbance the energy of light may be reduced or ultimately lost, leading to a distorted and white, non-translucent image. In various embodiments, a clearing reagent and mountant optically clears the sample by matching the refractive index to minimizing the light scattering through the specimen and to the microscope objective.

In various embodiments, optical clearing may be performed via various different approaches, primarily being divided into chemical and matrix-based approaches. In various embodiments, chemical approaches include aqueous-based or solvent-based approaches to achieve a highly resolved 3D image for immunolabeling, immuno-cytochemistry, immuno-histochemistry, and/or immunofluorescence. In various embodiments, aqueous-based clearing approaches are generally used to avoid dehydration and toxicity, which can destroy the integrity of a sample.

In various embodiments, passive clarity technique (PACT) is a passive tissue clearing and immunolabeling protocol. In various embodiments, PACT is used for intact thick organs. In various embodiments, RIMS includes a protocol for passive tissue clearing and immunostaining of intact organs that is compatible for long-term storage and has imaging media that preserves fluorescent markers over months.

In various embodiments, refractive index matching solutions (RIMS) may be produced with sugar or glycerol for simple, passive immersion. This may be preferred with thinner or smaller samples, because they are easier to clear and can maintain fluorescent protein emission. In various embodiments, such immersion techniques may achieve less than 1.5 refractive index and can take days to achieve clearing, resulting in reduced image quality when compared to solvent approaches, due to refractive index mismatching between the cleared sample, the glass coverslip, and immersion oil (glass and oil have an RI of 1.51). As sugar or glycerol solutions may take extended periods for clearing, a sample can experience considerable shrinkage while losing lipid content. In various embodiments, commercially available solutions control morphological alterations and loss of lipid content while achieving a higher refractive index of 1.52. In various embodiments, considerations for clearing include sample type and thickness so that there is minimal shrinkage of the sample and preservation of lipid content and fluorescence.

In various embodiments, perfusion-assisted agent release in situ (PARS) includes a method for whole-body clearing and phenotyping compatible with endogenous fluorescence. In various embodiments, all steps for PARS, including preservation, clearing, and labeling, are performed in situ prior to tissue extraction. In various embodiments, PARS, together with RIMS, transform opaque, intact, whole-organisms into optically transparent, fluorescently labeled samples for visualization with conventional confocal microscopy and phenotypic analysis at the cellular, subcellular, and/or single-molecule transcripts level as described in Single-Cell Phenotyping within Transparent Intact Tissue through Whole-Body Clearing by Yang et al. Cell. Vol 158, Issue 4, P945-958, Aug. 14, 2014 (accessible online at https://doi.org/10.1016/j.cell.2014.07.017).

A biological sample may comprise one or a plurality of analytes of interest. The opto-fluidic instruments disclosed herein can be used to detect and analyze a wide variety of different analytes. In some aspects, an analyte can include any biological substance, structure, moiety, or component to be analyzed. For example, the analyte may include any biomolecule or chemical compound, including a macromolecule such as a protein or peptide, a lipid or a nucleic acid molecule, or a small molecule, including organic or inorganic molecules. The analyte may be a cell or a microorganism, including a virus, or a fragment or product thereof An analyte can be any substance or entity for which a specific binding partner (e.g., an affinity binding partner) can be developed and detected (e.g., using the opto-fluidic instruments disclosed herein).

Analytes of particular interest may include nucleic acid molecules, such as DNA (e.g. genomic DNA, mitochondrial DNA, plastid DNA, viral DNA, etc.) and RNA (e.g. mRNA, microRNA, rRNA, snRNA, viral RNA, etc.), and synthetic and/or modified nucleic acid molecules, (e.g. including nucleic acid domains comprising or consisting of synthetic or modified nucleotides such as LNA, PNA, morpholino, etc.), proteinaceous molecules such as peptides, polypeptides, proteins or prions or any molecule which includes a protein or polypeptide component, etc., or fragments thereof. The analyte may be a single molecule or a complex that contains two or more molecular subunits, e.g., including but not limited to complexes between proteins or peptides and nucleic acid molecules such as DNA or RNA, e.g., interactions between proteins and nucleic acids, e.g., regulatory factors, such as transcription factors, and DNA or RNA.

In some embodiments, the opto-fluidic instruments described herein can be utilized for the in situ detection and analysis of cellular analytes, (such as nucleic acid sequences), such as fluorescent in situ hybridization (FISH)-based methods, in situ transcriptomic analysis, or in situ sequencing, for example from intact tissues or samples in which the spatial information has been preserved. In some aspects, the embodiments can be applied in an imaging or detection method for multiplexed nucleic acid analysis. In some aspects, the provided opto-fluidic instruments can be used to detect a signal associated with a detectable label of a nucleic acid probe that is hybridized to a target sequence of a target nucleic acid in a biological sample.

Disclosed herein, in some aspects, are labelling agents (e.g., nucleic acid probes and/or probe sets) that are introduced into a cell or used to otherwise detect an analyte in a biological sample such as a tissue sample. The labelling agents include nucleic acid-based probes (e.g., the primary probes disclosed herein and/or any detectable probe disclosed herein) and may comprise any of a variety of entities that can hybridize to a nucleic acid, typically by Watson-Crick base pairing, such as DNA, RNA, LNA, PNA, etc. The nucleic acid probes may comprise a hybridization region that is able to directly or indirectly bind to at least a portion of a target sequence in a target nucleic acid. The nucleic acid probe may be able to bind to a specific target nucleic acid (e.g., an mRNA, or other nucleic acids disclosed herein).

Specific probe designs can vary depending on the application and any suitable probe or probe set may be utilized and detected using the opto-fluidic instruments described herein. In some aspects, the probes or probe sets described herein, or intermediate probes (e.g., a secondary probe, and/or a higher order probe) can be selected from the group consisting of a circular probe, a circularizable probe, and a linear probe. In some embodiments, a circular probe is pre-circularized prior to hybridization to a target nucleic acid and/or one or more other probes. In some embodiments, a circularizable probe is circularized (e.g., by ligation) upon hybridization to a target nucleic acid and/or one or more other probes such as a splint. In some embodiments, a linear probe can be one that comprises a target recognition sequence and a sequence that does not hybridize to a target nucleic acid, such as a 5′ overhang, a 3′ overhang, and/or a linker or spacer (which may comprise a nucleic acid sequence, such a one or more barcode sequence, or a non-nucleic acid moiety). In some embodiments, the sequence (e.g., the 5′ overhang, 3′ overhang, and/or linker or spacer) is non-hybridizing to the target nucleic acid but may hybridize to one another and/or one or more other probes, such as detectably labeled probes.

In some embodiments, a primary probe, a secondary probe, and/or a higher order probe disclosed herein can comprise a padlock-like probe or probe set, such as one described in U.S. Pat. 8,551,710, US 2020/0224244, US 2019/0055594, US 2021/0164039, US 2016/0108458, or US 2020/0224243, each of which is incorporated herein by reference in its entirety. Any suitable combination of the probe designs described herein can be used.

In some embodiments, the probes or probe sets described herein (e.g., a primary probe,) or a secondary probe, and/or a higher order probe disclosed herein can comprise two or more parts. In some cases, a probe can comprise one or more features of and/or be modified based on: a split FISH probe or probe set described in WO 2021/167526A1 or Goh et al., “Highly specific multiplexed RNA imaging in tissues with split-FISH,” Nat Methods 17 (7):689-693 (2020), which are incorporated herein by reference in their entireties; a Z-probe or probe set, such as one described in U.S. Pat. Nos. 7,709,198 B2, 8,604,182 B2, 8,951,726 B2, 8,658,361 B2, or Tripathi et al., “Z Probe, An Efficient Tool for Characterizing Long Non-Coding RNA in FFPE Tissues,” Noncoding RNA 4 (3):20 (2018), which are incorporated herein by reference in their entireties; an HCR initiator or amplifier, such as one described in U.S. Pat. No. 7,632,641 B2, US 2017/0009278 A1, U.S. Pat. No. 10,450,599 B2, or Choi et al., “Third-generation in situ hybridization chain reaction: multiplexed, quantitative, sensitive, versatile, robust,” Development 145 (12): dev165753 (2018), which are incorporated herein by reference in their entireties; a PLAYR probe or probe set, such as one described in US 2016/0108458 A1 or Frei et al., “Highly multiplexed simultaneous detection of RNAs and proteins in single cells,” Nat Methods 13 (3):269-75 (2016), which are incorporated herein by reference in their entireties; a PLISH probe or probe set, such as one described in US 2020/0224243 A1 or Nagendran et al., “Automated cell-type classification in intact tissues by single-cell molecular profiling,” eLife 7:e30510 (2018), which are incorporated herein by reference in their entireties; a RollFISH probe or probe set such as one described in Wu et al., “RollFISH achieves robust quantification of single-molecule RNA biomarkers in paraffin-embedded tumor tissue samples,” Commun Biol 1, 209 (2018), which is hereby incorporated by reference in its entirety; a MERFISH probe or probe set, such as one described in US 2022/0064697 A1 or Chen et al., “Spatially resolved, highly multiplexed RNA profiling in single cells,” Science 348 (6233):aaa6090 (2015), which are incorporated herein by reference in their entireties; a primer exchange reaction (PER) probe or probe set, such as one described in US 2019/0106733 A1, which is hereby incorporated by reference in its entirety.

In some instances, probes and/or probe sets are directly labeled with one or more detectable labels (e.g., an optically detectable label, such as a florescent moiety) that are detected on the opto-fluidic instruments disclosed herein. In other instances, probes and/or probe sets comprise a target binding region and one or more nucleic acid barcode sequences that identify the analyte. In these embodiments, the barcode sequence(s) may be detected on the opto-fluidic instruments disclosed herein to identify the analyte in the sample. In some instances, a probe or probe set disclosed herein is a circularizable probe or probe set (e.g., a padlock probe or padlock-like probe) comprising a barcode region comprising one or more barcode sequences.

The probes and/or probe sets describe herein may comprise any suitable number of barcode sequences. In some embodiments, the probes or probe sets may comprise 1, 2, 3, 4, 5, 6, 7, 8, 9, 10, 11, 12, 13, 14, 15 or more, 20 or more, 32 or more, 40 or more, or 50 or more barcode sequences. As an illustrative example, a first probe may contain a first target-binding sequence, a first barcode sequence, and a second barcode sequence, while a second, different probe may contain a second target-binding sequence (that is different from the first target-binding sequence in the first probe), the same first barcode sequence as in the first probe, but a third barcode sequence instead of the second barcode sequence. Such probes may thereby be distinguished by determining the various barcode sequence combinations present or associated with a given probe at a given location in a sample.

In some embodiments, a labelling agent may include analyte binding moiety that interacts with an analyte (e.g., a protein) in the sample (e.g., a cell or tissue sample) and a reporter oligonucleotide comprising one or more barcode sequences associated with the analyte and/or analyte binding moiety. For example, a labelling agent that is specific to one type of cell feature (e.g., a first protein) may have coupled thereto a first reporter oligonucleotide, while a labelling agent that is specific to a different cell feature (e.g., a second protein) may have a different reporter oligonucleotide coupled thereto. In some embodiments, an analyte binding moiety includes, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. For a description of exemplary labelling agents, reporter oligonucleotides, and methods of use, see, e.g., U.S. Pat. 10,550,429; U.S. Pat. Pub. 20190177800; and U.S. Pat. Pub. 20190367969, which are each incorporated by reference herein in their entirety.

In some embodiments, the nucleic acid probes, probe sets, reporter oligonucleotides, barcode sequences, etc. may be detected directly on the opto-fluidic instruments disclosed herein (e.g., primary probes comprise a detectable label, such as a florescent moiety), and/or by using secondary (or higher order) nucleic acid probes able to bind to the primary probes. In some embodiments, the nucleic acid probes (e.g., primary probes and/or secondary probes) are compatible with one or more biological and/or chemical reactions. For instance, a nucleic acid probe disclosed herein can serve as a template or primer for a polymerase (e.g., a circularized probe in a rolling circle amplification (RCA) reaction), a template or substrate for a ligase, a substrate for a click chemistry reaction, and/or a substrate for a nuclease (e.g., endonuclease or exonuclease for cleavage or digestion). In some instances, labelling agents (such as a primary probe set) are added to a biological sample (e.g., a cell or tissue sample) using the opto-fluidic instrument and subsequently detected using opto-fluidic instrument (e.g., using detectably labeled primary probes, sequential hybridization of detectable labelled oligonucleotides to primary probes, in situ sequencing (e.g., SBS, SBL, SBH), and the like). In some instances, labelling agents (such as a primary probe set) are added to a biological sample (e.g., a cell or tissue sample) outside the optofluidic instrument and the sample is loaded onto the opto-fluidic instruments disclosed herein for detection (e.g., using sequential hybridization of detectable labelled oligonucleotides, in situ sequencing (e.g., SBS, SBL, SBH), and the like).

In some embodiments, detection of the analytes, probes, probe sets, barcodes, etc. described herein can be performed in situ on the opto-fluidic instruments disclosed herein. In situ sequencing typically involves incorporation of a labeled nucleotide (e.g., fluorescently labeled mononucleotides or dinucleotides) in a sequential, template-dependent manner or hybridization of a labeled primer (e.g., a labeled random hexamer) to a nucleic acid template such that the identities (e.g., nucleotide sequence) of the incorporated nucleotides or labeled primer extension products can be determined, and consequently, the nucleotide sequence of the corresponding template nucleic acid. Aspects of in situ sequencing approaches are described, for example, in Mitra et al., (2003) Anal. Biochem. 320, 55-65, and Lee et al., (2014) Science, 343 (6177), 1360-1363. In addition, examples of methods and systems for performing in situ sequencing are described in US 2016/0024555, US 2019/0194709, and in U.S. Pat. Nos. 10,138,509, 10,494,662 and 10,179,932.

In some embodiments, sequencing can be performed by sequencing-by-synthesis (SBS). In some embodiments, a sequencing primer is complementary to sequences at or near the target to be detected (e.g., one or more barcode(s)). In such embodiments, sequencing-by-synthesis can comprise reverse transcription and/or amplification in order to generate a template sequence from which a primer sequence can bind. Exemplary SBS methods comprise those described for example, but not limited to, US 2007/0166705, US 2006/0188901, U.S. Pat. No. 7,057,026, US 2006/0240439, US 2006/0281109, US 2011/005986, US 2005/0100900, U.S. Pat. No. 9,217,178, US 2009/0118128, US 2012/0270305, US 2013/0260372, and US 2013/0079232.

In some embodiments, sequence analysis of nucleic acids (e.g., nucleic acids such as RCA products comprising barcode sequences) can be performed by sequential hybridization (e.g., sequencing by hybridization and/or sequential in situ fluorescence hybridization). Sequential fluorescence hybridization can involve sequential hybridization of detection probes comprising an oligonucleotide and a detectable label. In some embodiments, a method disclosed herein comprises sequential hybridization of the detectable probes disclosed herein, including detectably labeled probes (e.g., fluorophore conjugated oligonucleotides) and/or probes that are not detectably labeled per se but are capable of binding (e.g., via nucleic acid hybridization) and being detected by detectably labeled probes. Exemplary methods comprising sequential fluorescence hybridization of detectable probes are described in US 2019/0161796, US 2020/0224244, US 2022/0010358, US 2021/0340618, and WO 2021/138676, MERFISH (described for example in Moffitt, (2016) Methods in Enzymology, 572, 1-49), and hybridization-based in situ sequencing (HybISS) (described for example in Gyllborg et al., Nucleic Acids Res (2020) 48 (19):e112) all of which are incorporated herein by reference.

In some embodiments, sequencing can be performed using sequencing by ligation (SBL). Such techniques utilize DNA ligase to incorporate oligonucleotides and identify the incorporation of such oligonucleotides. The oligonucleotides typically have different labels that are correlated with the identity of a particular nucleotide in a sequence to which the oligonucleotides hybridize. Aspects and features involved in sequencing by ligation are described, for example, in Shendure et al. Science (2005), 309: 1728-1732, and in U.S. Pat. Nos. 5,599,675; 5,750,341; 6,969,488; 6,172,218; US and 6,306,597. Exemplary techniques for in situ SBL comprise, but are not limited to, STARmap (described for example in Wang et al., (2018) Science, 361 (6499) 5691) and US 2021/0164039).

In some embodiments, probe barcodes (e.g., plurality of probes or probe sets comprising one or more barcode sequences) or complements or products thereof are targeted by detectably labeled detection oligonucleotides, such as fluorescently labeled oligonucleotides. In some embodiments, one or more decoding schemes (e.g., sequential rounds of fluorescent probe hybridization) are used on the opto-fluidic instruments disclosed herein to decode the signals, such as fluorescence, for sequence identification. In any of the embodiments herein, barcodes (e.g., primary and/or secondary barcode sequences) can be analyzed (e.g., detected or sequenced using the opto-fluidic instruments disclosed herein) using any suitable methods or techniques, comprising those described herein, such as RNA sequential probing of targets (RNA SPOTs), sequential fluorescent in situ hybridization (seqFISH), single-molecule fluorescent in situ hybridization (smFISH), multiplexed error-robust fluorescence in situ hybridization (MERFISH), hybridization-based in situ sequencing (HybISS), in situ sequencing, targeted in situ sequencing, fluorescent in situ sequencing (FISSEQ), or spatially-resolved transcript amplicon readout mapping (STARmap). In some embodiments, the methods provided herein comprise analyzing the barcodes by sequential hybridization and detection with a plurality of labelled probes (e.g., detection oligonucleotides or detectable probes). Exemplary decoding schemes are described in Eng et al., “Transcriptome-scale Super-Resolved Imaging in Tissues by RNA SeqFISH+,” Nature 568 (7751):235-239 (2019); Chen et al., Science; 348 (6233):aaa6090 (2015); Gyllborg et al., Nucleic Acids Res (2020) 48 (19):e112; U.S. Pat. No. 10,457,980 B2; US 2016/0369329 A1; WO 2018/026873 A1; and US 2017/0220733 A1, all of which are incorporated by reference in their entirety. In some embodiments, these assays enable signal amplification, combinatorial decoding, and error correction schemes at the same time.

It is to be noted that, although the above discussion relates to an opto-fluidic instrument that can be used for in situ target molecule detection via probe hybridization, the discussion herein equally applies to any opto-fluidic instrument that employs any imaging or target molecule detection technique. That is, for example, an opto-fluidic instrument may include a fluidics module that includes fluids needed for establishing the experimental conditions required for the probing of target molecules in the sample. Further, such an opto-fluidic instrument may also include a sample module configured to receive the sample, and an optics module including an imaging system for illuminating (e.g., exciting one or more fluorescent probes within the sample) and/or imaging light signals received from the probed sample. The opto-fluidic instrument may also include other ancillary modules configured to facilitate the operation of the opto-fluidic instrument, such as, but not limited to, cooling systems, motion calibration systems, etc.

In some embodiments, the afore-mentioned sample preparation or processing steps may have to be performed in a sealed well or chamber of the opto-fluidic instrument. For example, the sample preparation or processing steps may include the incubation of the sample (e.g., in the presence of a reagent) in a sample device of the opto-fluidic instrument, and the incubation may be performed in a sealed chamber, for example to avoid evaporation. Heat for the incubation may be provided by heat sources that are thermally coupled to the sample device. For instance, a sealed sample device containing a sample may be placed in a thermal cycler to, for example, amplify molecules (e.g., DNA, RNA, etc.) in the sample that are to be detected.

In such cases, a heated lid of the thermal cycler may be in direct contact with, or otherwise thermally coupled to, a side of the sample device, delivering heat to the sample for incubating the same. Other sources of heat for incubating the sample may include but are not limited to thermoelectric coolers (TECs). For example, the hot-side of a TEC that may be in direct contact with, or otherwise thermally coupled to, a side of the sample device to provide heat for sample incubation.

Existing solutions for sealing a well to form a sealed chamber utilize a sealing tape or other cover, and place the same over an opening of the well. In most cases, the tape or cover is placed flush with the opening of the well. This is to reduce the space between the sample and the tape, so that heat can be delivered to the sample efficiently when delivered via the tape. For instance, when heat is delivered to a sample (e.g., in the presence of a fluid) via a heated thermal cycler lid that is contact or flush with the tape, then the heat may be delivered to the sample more efficiently when the space between the sample and the tape is low. This, however, may not be desirable because a disturbance to the sample or well can result in the formation of a fluid capillary bridge between the top surface of the bottom of the well and the tape. For example, a fluid that is in the well may wick up and form a bridge, with undesirable consequences such as but not limited to the de-wetting of the sample/well, leaking, etc. Accordingly, there exists a need for a system for forming a sealed chamber that address at least the identified deficiencies.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### II. Example Descriptions of Terms

As used herein the specification, “a” or “an” may mean one or more. As used herein in the claim(s), when used in conjunction with the word “comprising,” the words “a” or “an” may mean one or more than one. Some embodiments of the disclosure may consist of or consist essentially of one or more elements, method steps, and/or methods of the disclosure. It is contemplated that any method or composition described herein can be implemented with respect to any other method or composition described herein and that different embodiments may be combined.

As used herein, “substantially” means sufficient to work for the intended purpose. The term “substantially” thus allows for minor, insignificant variations from an absolute or perfect state, dimension, measurement, result, or the like such as would be expected by a person of ordinary skill in the field but that do not appreciably affect overall performance. When used with respect to numerical values or parameters or characteristics that can be expressed as numerical values, “substantially” means within ten percent.

The use of the term “or” in the claims is used to mean “and/or” unless explicitly indicated to refer to alternatives only or the alternatives are mutually exclusive, although the disclosure supports a definition that refers to only alternatives and “and/or.” For example, “x, y, and/or z” can refer to “x” alone, “y” alone, “z” alone, “x, y, and z,” “(x and y) or z,” “x or (y and z),” or “x or y or z.” It is specifically contemplated that x, y, or z may be specifically excluded from an embodiment. As used herein “another” may mean at least a second or more.

The term “ones” means more than one.

As used herein, the term “plurality” can be 2, 3, 4, 5, 6, 7, 8, 9, 10, or more.

As used herein, the term “set of” means one or more. For example, a set of items includes one or more items.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or some other suitable combination

As used herein, the term “about” refers to include the usual error range for the respective value readily known. Reference to “about” a value or parameter herein includes (and describes) embodiments that are directed to that value or parameter per se. For example, description referring to “about X” includes description of “X”. In some embodiments, “about” may refer to ±15%, ±10%, ±5%, or ±1% as understood by a person of skill in the art.

As used herein, in some instances, the term “thermal coupling”, or variants thereof, refer to configurations of two or more components that allow heat to be exchanged with each other directly (e.g., in direct contact) or indirectly such that the temperature of one or both of them increases or decreases.

While the present teachings are described in conjunction with various embodiments, it is not intended that the present teachings be limited to such various embodiments. On the contrary, the present teachings encompass various alternatives, modifications, and equivalents, as will be appreciated by those of skill in the art.

In describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

### III. Opto-Fluidic Instruments for Analysis of Biological Samples

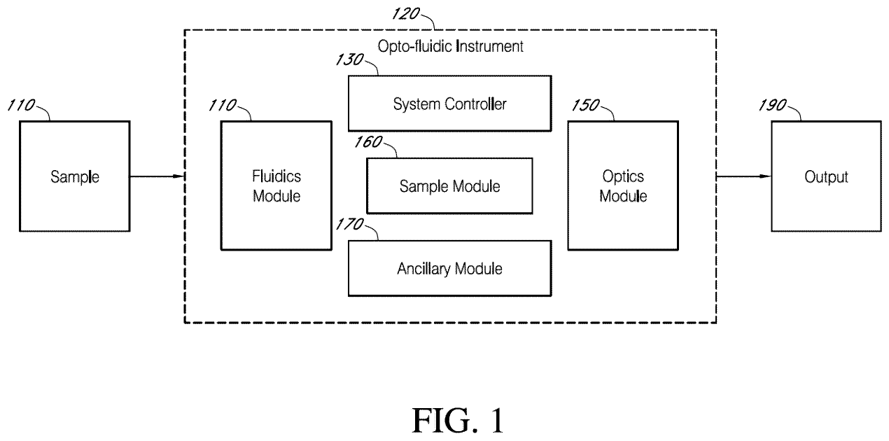

FIG. 1 shows an example workflow of analysis of a biological sample 110 (e.g., cell or tissue sample) using an opto-fluidic instrument 120, according to various embodiments. In various embodiments, the sample 110 can be a biological sample (e.g., a tissue) that includes molecules such as DNA, RNA, proteins, antibodies, etc. For example, the sample 110 can be a sectioned tissue that is treated to access the RNA thereof for labeling with circularizable DNA probes. Ligation of the probes may generate a circular DNA probe which can be enzymatically amplified and bound with fluorescent oligonucleotides, which can create bright signal that is convenient to image and has a high signal-to-noise ratio.

In various embodiments, the sample 110 may be placed in the opto-fluidic instrument 120 for analysis and detection of the molecules in the sample 110. In various embodiments, the opto-fluidic instrument 120 can be a system configured to facilitate the experimental conditions conducive for the detection of the target molecules. For example, the opto-fluidic instrument 120 can include a fluidics module 140, an optics module 150, a sample module 160, and an ancillary module 170, and these modules may be operated by a system controller 130 to create the experimental conditions for the probing of the molecules in the sample 110 by selected probes (e.g., circularizable DNA probes), as well as to facilitate the imaging of the probed sample (e.g., by an imaging system of the optics module 150). In various embodiments, the various modules of the opto-fluidic instrument 120 may be separate components in communication with each other, or at least some of them may be integrated together.

In various embodiments, the sample module 160 may be configured to receive the sample 110 into the opto-fluidic instrument 120. For instance, the sample module 160 may include a sample interface module (SIM) that is configured to receive a sample device (e.g., cassette) onto which the sample 110 can be deposited. That is, the sample 110 may be placed in the opto-fluidic instrument 120 by depositing the sample 110 (e.g., the sectioned tissue) on a sample device that is then inserted into the SIM of the sample module 160. In some instances, the sample module 160 may also include an X-Y stage onto which the SIM is mounted. The X-Y stage may be configured to move the SIM mounted thereon (e.g., and as such the sample device containing the sample 110 inserted therein) in perpendicular directions along the two-dimensional (2D) plane of the opto-fluidic instrument 120. Additional discussion related the SIM can be found in U.S. Provisional Application No. 63/348,879, filed Jun. 3, 2022, titled “Methods, Systems, and Devices for Sample Interface,” which is incorporated herein by reference in its entirety.

The experimental conditions that are conducive for the detection of the molecules in the sample 110 may depend on the target molecule detection technique that is employed by the opto-fluidic instrument 120. For example, in various embodiments, the opto-fluidic instrument 120 can be a system that is configured to detect molecules in the sample 110 via hybridization of probes. In such cases, the experimental conditions can include molecule hybridization conditions that result in the intensity of hybridization of the target molecule (e.g., nucleic acid) to a probe (e.g., oligonucleotide) being significantly higher when the probe sequence is complementary to the target molecule than when there is a single-base mismatch. The hybridization conditions include the preparation of the sample 110 using reagents such as washing/stripping reagents, probe reagents, etc., and such reagents may be provided by the fluidics module 140. Examples of the washing buffer include but are not limited to deionized water, phosphate-buffered saline (PBS), PBS with dimethyl sulfoxide (DMSO), and/or the like. The stripping buffer can be but is not limited to DMSO, a surfactant, and/or the like. In some instances, the surfactant can be or include polysorbate 20. In some instances, the stripping buffer may include the surfactant in a weight proportion of about 0.1%. The probe reagent can be fluorescent probes, such as but not limited to oligonucleotide probes.

In various embodiments, the fluidics module 140 may include one or more components that may be used for storing the reagents, as well as for transporting said reagents to and from the sample device containing the sample 110. For example, the fluidics module 140 may include reservoirs configured to store the reagents, as well as a waste container configured for collecting the reagents (e.g., and other waste) after use by the opto-fluidic instrument 120 to analyze and detect the molecules of the sample 110. Further, the fluidics module 140 may also include pumps, tubes, pipettes, etc., that are configured to facilitate the transport of the reagent to the sample device (e.g., and as such the sample 110). For instance, the fluidics module 140 may include pumps (“reagent pumps”) that are configured to pump washing/stripping reagents to the sample device for use in washing/stripping the sample 110 (e.g., as well as other washing functions such as washing an objective lens of the imaging system of the optics module 150). In some cases, a stage (e.g., a Y-Z stage) may be configured to move the pipettes along one or more directions, to and from the sample device containing the sample 110, so that the various reagents may be dispensed in the sample device, and spent reagents may be extracted from the sample device.

In various embodiments, the ancillary module 170 can be a cooling system of the opto-fluidic instrument 120, and the cooling system may include a network of coolant-carrying tubes that are configured to transport coolants to various modules of the opto-fluidic instrument 120 for regulating the temperatures thereof. In such cases, the fluidics module 140 may include coolant reservoirs for storing the coolants and pumps (e.g., “coolant pumps”) for generating a pressure differential, thereby forcing the coolants to flow from the reservoirs to the various modules of the opto-fluidic instrument 120 via the coolant-carrying tubes. In some instances, the fluidics module 140 may include returning coolant reservoirs that may be configured to receive and store returning coolants, i.e., heated coolants flowing back into the returning coolant reservoirs after absorbing heat discharged by the various modules of the opto-fluidic instrument 120. In such cases, the fluidics module 140 may also include cooling fans that are configured to force air (e.g., cool and/or ambient air) into the returning coolant reservoirs to cool the heated coolants stored therein. In some instance, the fluidics module 140 may also include cooling fans that are configured to force air directly into a component of the opto-fluidic instrument 120 so as to cool said component. For example, the fluidics module 140 may include cooling fans that are configured to direct cool or ambient air into the system controller 130 to cool the same.

As discussed above, the opto-fluidic instrument 120 may include an optics module 150 which include the various optical components of the opto-fluidic instrument 120, such as but not limited to a camera, an illumination module (e.g., LEDs), an objective lens, and/or the like. The optics module 150 may include a fluorescence imaging system that is configured to image the fluorescence emitted by the probes (e.g., oligonucleotides) in the sample 110 after the probes are excited by light from the illumination module of the optics module 150.

In various embodiments, the system controller 130 may be configured to control the operations of the opto-fluidic instrument 120 (e.g., and the operations of one or more modules thereof). In some instances, the system controller 130 may take various forms, including a processor, a single computer (or computer system), or multiple computers in communication with each other. In various embodiments, the system controller 130 may be communicatively coupled with data storage, set of input devices, display system, or a combination thereof. In some cases, some or all of these components may be considered to be part of or otherwise integrated with the system controller 130, may be separate components in communication with each other, or may be integrated together. In other examples, the system controller 130 can be, or may be in communication with, a cloud computing platform.

In various embodiments, the opto-fluidic instrument 120 may analyze the sample 110 and may generate the output 190 that includes indications of the presence of the target molecules in the sample 110. For instance, with respect to the example embodiment discussed above where the opto-fluidic instrument 120 employs a hybridization technique for detecting molecules, the opto-fluidic instrument 120 may cause the sample 110 to undergo successive rounds of fluorescent probe hybridization (using two or more sets of fluorescent probes, where each set of fluorescent probes is excited by a different color channel) and be imaged to detect target molecules in the probed sample 110. In such cases, the output 190 may include optical signatures (e.g., a codeword) specific to each gene, which allow the identification of the target molecules.

### IV. Sample Device and Lid Assembly

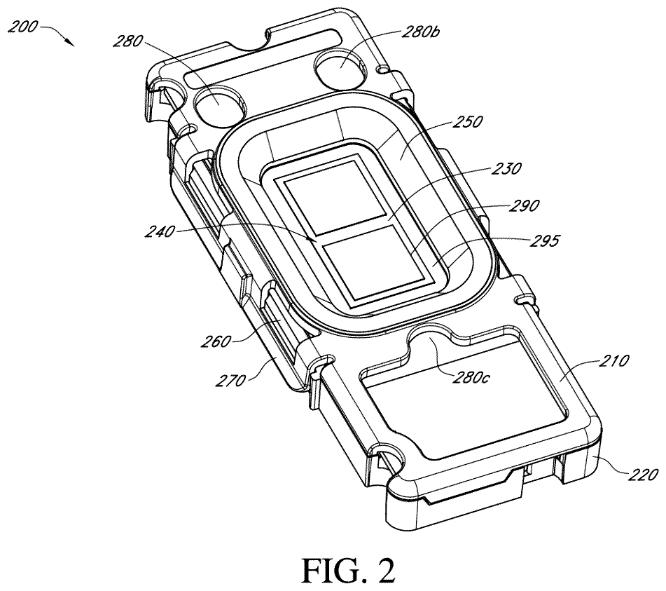

FIG. 2 illustrates a sample device 200 for receiving a sample that is to be probed to detect molecules therein. The sample device 200 is configured to be inserted or otherwise placed in a SIM of a sample module (e.g., such as the sample module 160 of the opto-fluidic instrument 120 of FIG. 1). In some instances, the sample device 200 may be a cassette. In various embodiments, the sample device 200 may include a top portion 210 and a bottom portion 220 that are configured to releasably engage with or couple to each other while a substrate 230 is located therebetween such that a well 240 forms. That is, when the top portion 210 and the bottom portion 220 releasably couple to each other, a gap which is configured to receive the substrate 230 forms therebetween.

In some instances, the top portion 210 may have one or more snap joints 270 (e.g., cantilevered snap joint) and the bottom portion 220 may have one or more lugs 260 (e.g., cantilevered lugs). In yet some instances, the top portion 210 may have one or more lugs and the bottom portion 220 may have one or more snap joints. In various embodiments, the one or more snap joints 270 and the one or more lugs 260 may engage with, or couple to, each other with the substrate sandwiched in between to lock the top portion 210 and the bottom portion 220 together, thereby forming the well 240 that has the substrate 230 (e.g., in particular, the exposed area of the substrate 230) as a floor. That is, the well 240 forms within the top portion 210 of the sample device 200 and is defined by the substrate 230 (e.g., forming the floor of the well 240) and the gasket 250 (e.g., forming the wall of the well 240). In some instances, the substrate 230 can be a glass slide.

In various embodiments, the sample device 200 may also include a gasket 250 that may serve as a wall for the well 240. In some instances, the gasket 250 is configured to form a seal between the substrate 230 and the top portion 210. In some instances, the gasket 250 may provide a “stadium-seating” wall to the well 240. That is, the gasket 250 may have an angled inner surface between a first opening and a second opening, where the cross-sectional area of the first opening is smaller than that of the second opening. When positioned in the sample device 200, the first opening of the gasket 250 makes contact with the substrate 230 forming the seal, which is the boundary of the exposed area of the substrate 230. Further, the angled inner surface of the gasket 250 makes a receding wall (e.g., which corresponds to the “stadium-seating” wall to the well 240) that terminates at the larger second opening of the gasket.

In various embodiments, the substrate 230 may include fiducials or markers that are configured to guide the placement of the sample thereon. In some instances, the substrate 230 may include sample section boundary 290 that indicate the area of the substrate where samples may be positioned. The sample section boundary 290 may be positioned within an imageable section boundary 295, which encloses the area of the substrate 230 that an imaging system (e.g., such as an imaging system of the optics module 150 of the opto-fluidic instrument 120 of FIG. 1) can access and image when the sample device is inserted into the sample module of the opto-fluidic instrument. The substrate 230 may have linear dimensions (e.g., length, width) in the range from about 1 cm to about 3 cms, from about 1.5 cms to about 2.5 cms, including values and subranges therebetween. For instance, the sample section boundary 280 may have a linear dimension of about 1 cm.

In various embodiments, the top portion 210 may have multiple snap joint elements 280a-280c (alternatively referred as 280). A snap joint element 280 of the top portion 210 can be any suitable feature that is configured to engage with another snap joint element (e.g., of a lid of the sample device 200) to form a snap joint. For instances, the snap joint element 280 of the top portion can be an aperture, a recess, etc., and may be configured to form a snap joint when coupled to another snap joint such as but not limited to a clip, a hook, etc., (of a sample device lid, for example). The multiple snap joint elements 280 may be arranged on the top portion 210 such that at least a pair of the multiple snap joint elements 280 are located substantially opposite from each other. In some instances, the term “substantially opposite” as used herein may refer to at least a pair of the multiple snap joint elements 280 being positioned opposite from each other across the well 240.

For example, as shown in FIG. 2, the pair of snap joint elements 280a and 280c (or 280b and 280c) are positioned across the well 240 from each other, and may be described as being located “substantially opposite” from each other. In other instances, the term “substantially opposite” may refer to at least a pair of the multiple snap joint elements 280 being distanced from each other by at least half the length of the well 240. That is, for example, if one snap joint element (e.g., 280a or 280b) is located on one side of the well 240, then another snap joint element that is located on the top portion 210 at least half the length of the well 240 away from the other snap joint element 280a or 280b may be described as being positioned substantially opposite from the other snap joint element 280a or 280b. The number of the multiple snap joint elements 280 can be 2, 3, 4, 5, etc.

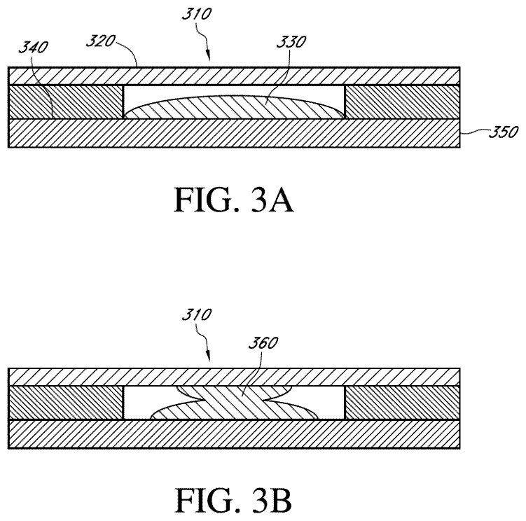

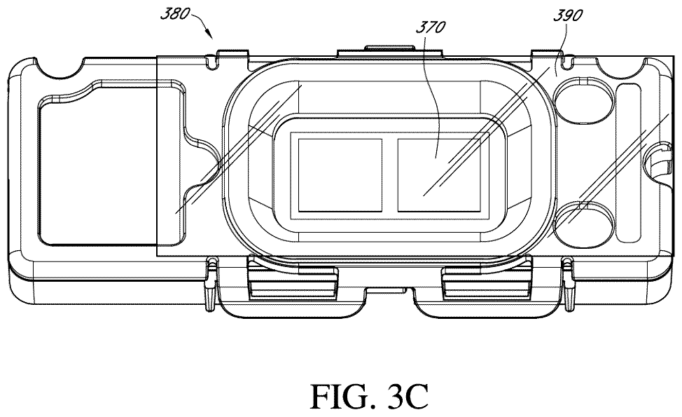

FIGS. 3A-3C illustrate bridging in a sample device sealed with a tape, according to various embodiments. The sample device 310, which can be the same as, or substantially similar to, the sample device 200 of FIG. 2, may include a substrate 350, which can be the same as, or substantially similar to, the substrate 230 of FIG. 2. In various embodiments, the sample device 310 may be used to prepare or process a sample for the detection of molecules therein, and part of the sample preparation or processing can be the incubation of the sample in the sample device 310 while the sample device 310 is sealed with a cover. As discussed above, existing solutions for sealing a well that contains a sample for incubation purposes include the use of a flat polymer tape 320 (e.g., polyethylene tape, polypropylene tape, polyester tape, polyolefin tape, etc.) so as to reduce the space between the sample therein and the tape 320 (e.g., so heat provided by a heat source from above the tape 320 is delivered to the sample efficiently).

Such solutions, however, may have undesirable consequences when the sample is in the presence of a fluid or reagent 330, such as the formation of a bridge 360 (e.g., capillary bridge) between the tape 310 and the substrate 350, as shown in FIG. 3B. Such bridging issues may occur when the sample device 310 is disturbed, for example, due to vibrations from a source of vibration that is internal to the opto-fluidic instrument (e.g., pumps, cooling fans, etc.) or external to the opto-fluidic instrument (e.g., background environment, pedestrians in motion in the vicinity of the opto-fluidic instrument, etc.). In such cases, the reagent 330 in the sample device 310 may wick up and contact the inner surface of the tape 320, forming the bridge 360. FIG. 3C shows an example illustration of a bridge 370 that is formed in a sample device 380 that is sealed with a polymer tape 390 when the sample device 380 is tilted momentarily. Bridges 360, 370 can be sources of leaks, or can cause the de-wetting of samples in the sample device 310, 380, and as such are undesirable. In contrast to current solutions that reduce the space between a sample in a well and a cover or tape that seals the well, various embodiments of the current disclosure disclose a sample device lid with a raised cover that can reduce or eliminate the formation of bridges in sample devices that are covered by the lid.

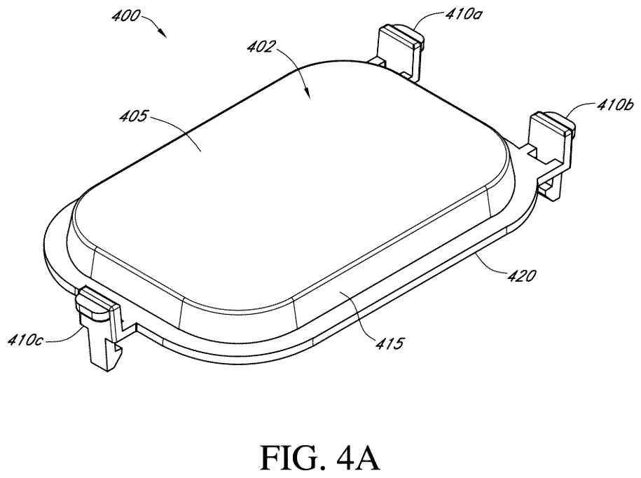

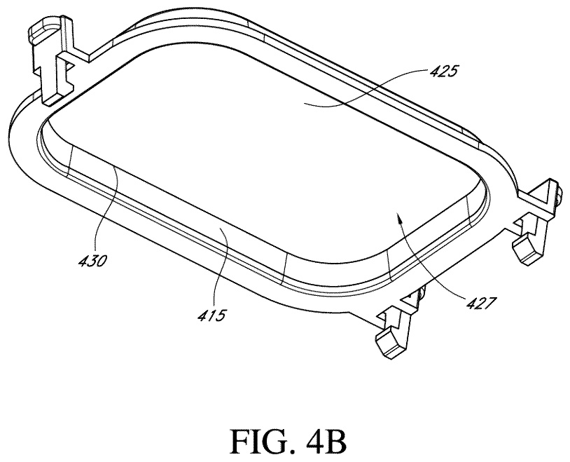

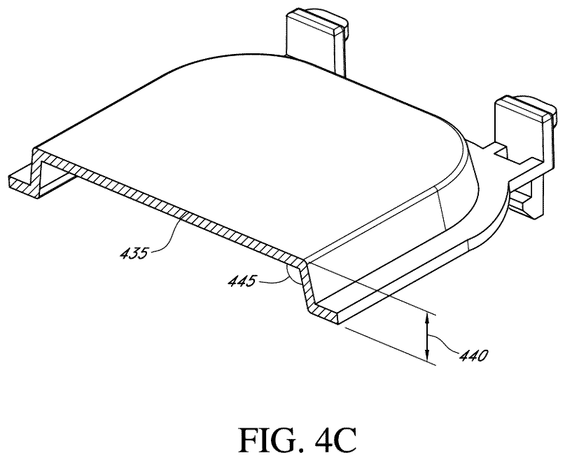

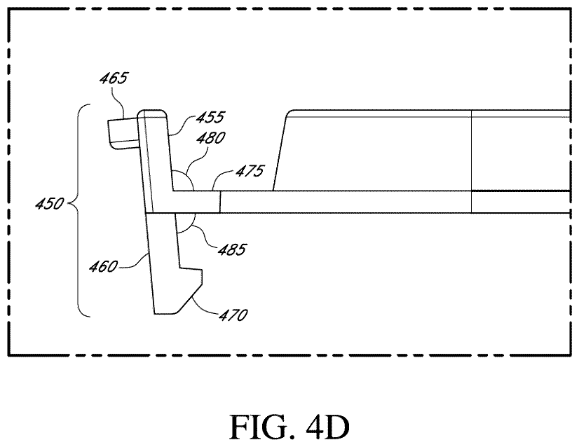

FIGS. 4A-4D illustrate views of an example lid 400 for covering a sample device, such as the sample device 200 of FIG. 2. FIG. 4A and FIG. 4B show an isometric view and a bottom view of the lid 400, in various embodiments. Further, FIG. 4C shows a cross-sectional view of the lid 400 and FIG. 4D shows a close up view of a snap joint element 410 of the lid 400, in various embodiments. In some embodiments, the lid 400 includes a cover 402 with an outer surface 405 and an inner surface 425 separated by a thickness 435 of the cover 402. The outer surface 405 may be shaped to fully engage with a thermal cycle lid. For example, the outer surface 405 can be a planar outer surface, as illustrated in FIGS. 4A-4D. The lid 400 also includes a skirt 415 that extends about the perimeter 430 of the cover 402. That is, the skirt 415 may extend about or around the perimeter 430 of the inner surface 425 of the lid 400. In some embodiments, the skirt 415 and the inner surface 425 define a recess 427 having a height 440 between the inner surface 425 and the edge or periphery of the skirt 415. In some embodiments, the lid 400 is made of a polymer. In various embodiments, the lid is made of at least one of: polyethylene (PE), polyethylene terephthalate (PET), high density PET, polyurethane (PU), polystyrene (PS), polypropylene (PP), polycarbonate (PC), acrylonitrile butadiene styrene (ABS), acetal, acrylic, PEEK, polyvinyl chloride (PVC), polyamide, polyimide, polyamide-imide, fluorinated ethylene propylene (FEP), ethylene tetrafluoroethylene (ETFE), polyphenylene oxide, and/or polyphenylsulfone (PPSU). In some embodiments, the lid 400 is fabricated using injection molding. In some embodiments, the lid 400 is fabricated using 3D printing techniques. In various embodiments, the lid 400 is fabricated using vacuum thermoforming. In some embodiments, the skirt 415 may be angled with respect to the inner surface 425, i.e., the skirt 415 may extend about the perimeter 430 of the inner surface 425 at an angle 445. In some embodiments, the angle 445 is less than 90°. In some embodiments, the angle 445 is greater than 90°. For example, the angle 445 can be in the range from about 75° to about 120°, from about 90° to about 120°, from about 100° to about 120°, from about 110° to about 120°, including values and subranges therebetween. In some embodiments, an angle 445 greater than 90° is used for design for manufacturability purposes (e.g., for injection molding).

In various embodiments, the skirt 415 includes multiple snap joint elements 410a, 410b, 410c (collectively referred to as 410) that are arranged on the skirt 415 substantially opposite from each other. In some instances, the term “substantially opposite” as used herein may refer to at least a pair of the multiple snap joint elements 410 being positioned opposite from each other across the cover 402 or the outer surface 405 of the lid 400. For example, as shown in FIG. 4A, the pair of snap joint elements 410a and 410c (or 410b and 410c) are positioned across the cover 402 from each other, and may be described as being located substantially opposite from each other. In other instances, the term “substantially opposite” may refer to at least a pair of the multiple snap joint elements 410 being distanced from each other by at least half the length of the cover 402. That is, for example, if one snap joint element (e.g., 410a or 410b) is located on one side of the cover 402, then another snap joint element that is located on the skirt 415 at least half the length of the cover 402 away from the other snap joint element 410a or 410b may be described as being positioned substantially opposite from the other snap joint element 410a or 410b. The number of the multiple snap joint elements 410 can be 2, 3, 4, 5, etc. In some instances, only one 410c of the multiple snap joint elements 410 may be on one side of the cover 402 and the rest (e.g., two 410a, 410b, or three of the multiple snap joint elements 410) may be positioned substantially opposite from the one 410c of the multiple snap joint elements 410.

In various embodiments, the skirt 415 may include a flange 420. In some instances, the flange 420 may extend around an edge or periphery of the skirt 415, and further may extend out parallel to the outer surface 405 of the cover 402. In some instances, the skirt 415 may have the shape of a closed ribbon, where one edge of the closed ribbon corresponds to the edge that meets the inner surface 425 of the lid 400 and the other edge includes the flange 420 that extends around the cover 402 and also extends out parallel to the outer surface 405 of the cover 402 or the lid 400. In various embodiments, the afore-mentioned multiple snap joint elements 410 of the skirt 415 may be located on the flange 420 of the skirt 415.

In various embodiments, the multiple snap joint elements 410 of the lid 400 may be configured to engage with or couple to the corresponding multiple snap joint elements of a sample device, such as the multiple snap joint elements 280 of FIG. 2. For example, a snap joint element 410 of the lid 400 can be a clip. For instance, the snap joint element 410 can be a cantilevered clip configured to clip onto the aperture or recess on the top portion 210 of the sample device 200. FIG. 4D shows a close up view of a snap joint element 410, in various embodiments. The snap joint element 410 includes a tab section 450 and a support section 475. In some instances, the support section 475 may be extended from the skirt 415. In some instances, the support section 475 may be extended from the flange 420, and may have, in some cases, same thickness as that of the flange 420. Further, the support section 475 may support the tab section 450.

In various embodiments, the tab section 450 of the snap joint element 410 may include a first part 460 and a second part 455 that are each angled with respect to the support tab 475. For example, the first part 460 may be at a first angle 485 with respect to the support tab 475 and the second part 455 may be at a second angle 480 with respect to the support tab 475. In some instances, the first angle 485 and the second angle 480 are equal to each other. For example, each of the first angle 485 and the second angle 480 is equal to about 90°. In other instances, the first angle 485 and the second angle 480 are different from each other. In some instances, the first angle 485 is greater than about 90° and the second angle 480 is less than about 90°. In some instances, the second angle 480 is greater than about 90° and the first angle 485 is less than about 90°. In some instances, the first angle 485 and/or the second angle 480 can be in the range from about 70° to about 110°, from about 70° to about 90°, from about to about 90°, from about 90° to about 110°, from about 95° to about 110°, from about 95° to about 115°, including values and subranges therebetween.

In some instances, the first part 460 and/or the second part 455 of the tab section 450 include a locking lip 470 and/or a nob 465, respectively, at their respective ends that are distal to the support section 475. That is, as noted above, the support section 475 supports the tab section 450, i.e., the support section 475 supports the first part 460 and the second part 455. In such cases, the first part 460 includes a locking lip 470 at one of its ends that is distal to where the support section 475 supports the first part 460. Similarly, the second part 455 includes a nob 465 at one of its ends that is distal to where the support section 475 supports the second part 455. In some instances, the locking lip 470 may extend from the first part 460 towards the cover 402. For example, the locking lip 470 may extend from the first part 460 at an angle equal to or greater than about 90° but less than bout 105°. In some instances, the nob 465 may extend from the second part 455 away from the cover 402 (e.g., angled with respect to the second part 455 at an angle of about 90°).

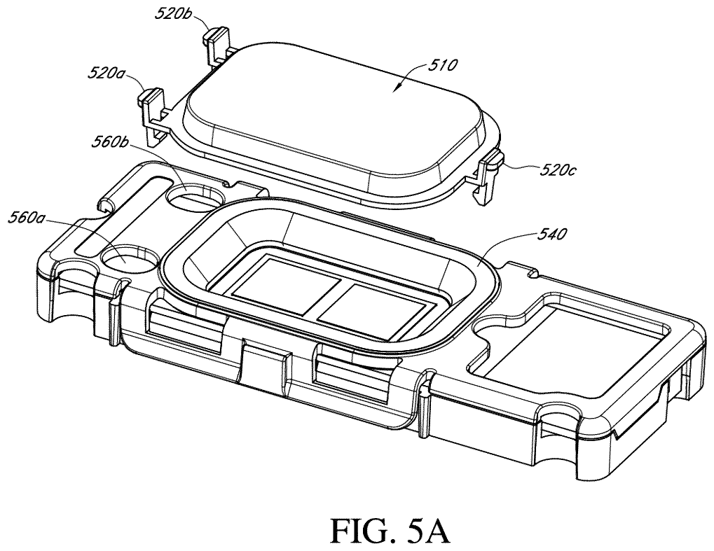

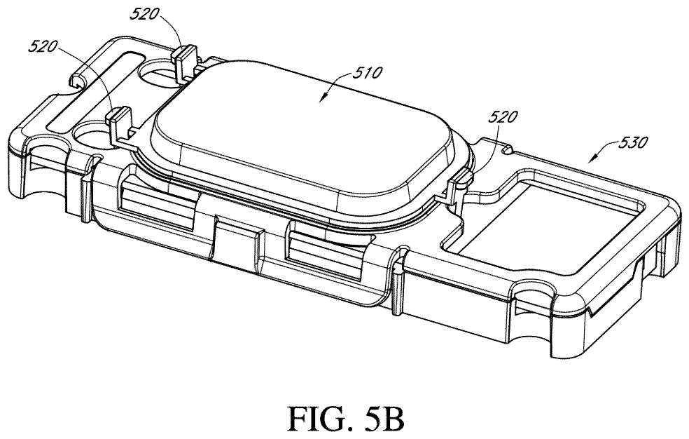

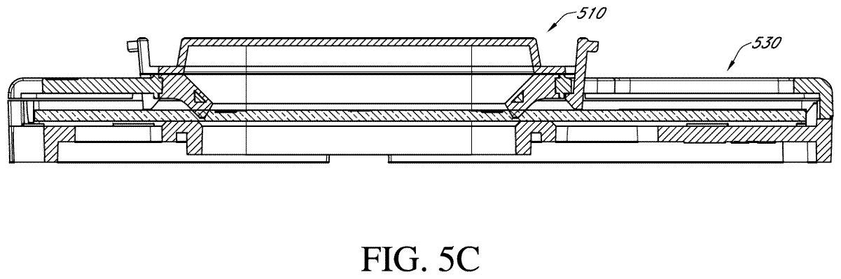

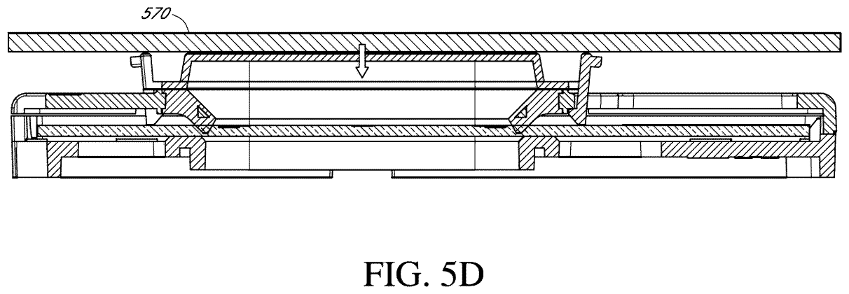

FIGS. 5A-5D illustrate engagement of the lid with the sample device (FIGS. 5A-5C), including in the presence of a thermal cycling lid (FIG. 5D), according to various embodiments. In various embodiments, as discussed above, a sealed chamber of an opto-fluidic instrument may be used to prepare or process a sample for the detection of molecules in the sample using probes. For instance, the sample may be incubated in the presence of reagents in a sealed chamber. In various embodiments, a sealed chamber suitable for such purposes may be formed by assembling the sample device 530 and the sample device lid 510. In some instances, the sample device 530 may be the same as or substantially similar to sample device 200, and the lid 510 may be the same as or substantially similar to the lid 400.

In various embodiments, the snap joint elements of the lid 510 and the snap joint elements of the sample device 530 may be configured such that when the lid 510 is engaged with or brought into contact with the sample device 530, the respective snap joint elements of the lid 510 and the sample device 530 align and couple with each other to lock the lid 510 in place on the sample device 530. That is, for example, the number of snap joint elements 520a, 520b, 520c (collectively referred as 520) of the lid 510 may be the same as the number of snap joint elements 560a, 560b, 560c (collectively referred as 560) of the sample device 530. In some instances, for both the lid 510 and the sample device 530, there may be two snap joint elements on one side (snap joint elements 520a, 520b for the lid 510, and snap joint elements 560a, 560b for the sample device 530) and one snap joint element (snap joint element 520c for the lid 510, and snap joint element 560c for the sample device 530) on the opposite side. This configuration is particularly desirable because it allows one to use only one hand to attach the lid 510, as well as detach the lid 510 from, the sample device 530. For example, a person may place their index and middle fingers on the snap joint elements 520a, 520b of the lid 510 and their thumb on the snap joint element 520c of the lid 510 to place the lid 510 on the sample device 530, and remove the lid therefrom.

The placing of the lid 510 on the sample device 530 may be illustrated below with reference to this particular configuration and FIG. 4D. It is to be understood, however, that for any other configuration (e.g., different numbers, positions, etc.) of snap joint elements of the lid 510 and the sample device 530, a similar discussion would apply. In some instances, a person may use their index and middle fingers to pull on the respective nobs 465 of the two snap joint elements 520a, 520b, while simultaneously using their thumb to push the nob 465 of the snap joint element 520c towards the other snap joint elements. This may pull the tab section 450 of a snap joint element 520 towards the support section 475, causing the second angle 480 to decrease and the first angle 485 to increase, further resulting in the first part 460 pulling away from support section 475. As the lid approaches the sample device with the snap joint elements aligned, the locking lip 470 is pulled away enough from the support section 475 to be able to enter the corresponding aperture or recess of the sample device, and lock into the aperture or recess when the nob is released.

In some instances, the lid 402, the snap joint element 410, or the tab section 450 may be made from flexible enough materials to allow the pulling or pushing of the tab section 450 without breakage. For example, the lid 402, the snap joint element 410, or the tab section 450 may be made from a polymer material such as but not limited to a polyphenylsulfone material, a polyethylene material, a polyurethane material, a polyethylene terephthalate material, a polystyrene material, a polycarbonate material, a polypropylene material, or a combination thereof. The lid 402, the snap joint element 410, or the tab section 450 can be made from any one or more of these materials using any suitable manufacturing technique, including but not limited to 3D printing, injection molding, rapid casting, etc.

In various embodiments, when the lid 510 is placed on the sample device 530, the flange of the lid 510 contacts the periphery of the well 550 of the sample device 530. For example, when the lid 510 contacts the sample device 530, the flange of the lid 510 contacts and remains flush with the outer periphery of the gasket 540. Further, as noted above the respective snap joint elements 520 and 560 of the lid 510 and 530 do lock with each other, forming a seal between the lid 510 and the outer periphery of the gasket 540 (e.g., the outer periphery of the well 550). For example, the snap joint elements 520 of the lid 510 may be cantilevered clips and the snap joint elements 560 of the sample device 530 may be apertures or recesses. In such cases, when the lid 510 is placed on the sample device 530 (e.g., the flange of the lid 510 contacts the outer periphery of the gasket 540), the cantilevered clips may clip into the respective apertures or recesses of the sample device 530 to lock the lid 510 to the sample device 530. In such cases, a sealed chamber is formed in the well 550, defined by the inner surface of the cover of the lid 510 as a ceiling, the substrate 555 as a floor, and the inner surface of the gasket 540 and the inner surface of the skirt of the lid 510 sealed together as a wall. Because of the recessed cover of the lid 510 (e.g., recessed by height 440 of FIG. 4C), the ceiling of this sealed chamber is higher than would have been the case if a tape was used to seal the well 550 of the sample device. As such, the sealed chamber of the assembly of the sample device 530 and the lid 510, shown in FIG. 5B (isometric view), FIG. 5C (side-view) and FIG. 5D (side view with a thermal cycler lid 570 pressing on the assembly) would reduce or eliminate any bridging issues that might have been caused due to a disturbance (e.g., vibration) to the assembly when fluid (e.g., reagent) is present in the assembly.

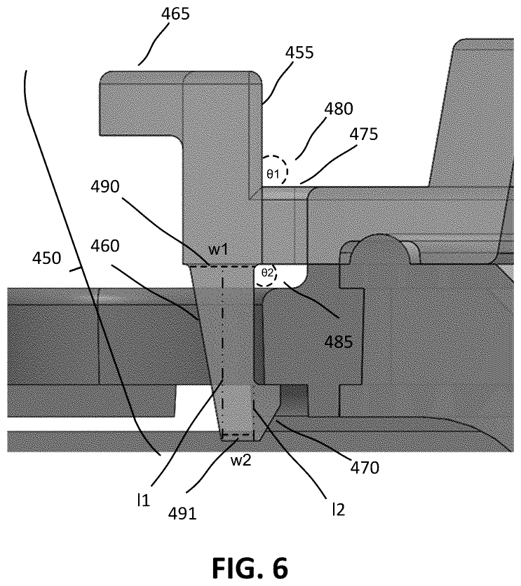

FIG. 6 provides an illustrative example of a cross-sectional view of a lid including a snap joint element, according to various embodiments. As discussed in FIG. 4D, the snap joint element includes a tab section 450 connected to a support section 475. In various embodiments, the tab section 450 of the snap joint element 410 includes a first part 460 and a second part 455 connected to the support section 475. In some instances, the first part 460 and/or the second part 455 extends substantially perpendicularly to the support section 475. In some instances, each of the first part 460 and the second part 455 have a proximal end connecting to the support section 475 and extend away from the support section 475 to a distal end. In some instances, the first part 460 includes a nob 465 at the distal end. In some instances, the second part 455 includes a locking lip 470 at the distal end. That is, as noted above, the support section 475 supports the tab section 450, i.e., the support section 475 supports the first part 460 and the second part 455. In some instances, the tab section 450 is configured to actuate (e.g., bend, pivot, hingedly rotate, etc.) where the first part 460 and the second part 455 connect to the support section 475. For example, a user may apply a force to the nob 465 to thereby cause the tab section 450 to rotate about the connection point with the support section 475.

FIGS. 5A-5D illustrate engagement of the lid 510 with the sample device (FIGS. including in the presence of a thermal cycling lid (FIG. 5D), according to various embodiments. In various embodiments, as discussed above, a sealed chamber of an opto-fluidic instrument may be used to prepare or process a sample for the detection of molecules in the sample using probes. For instance, the sample may be incubated in the presence of reagents in a sealed chamber. In various embodiments, a sealed chamber suitable for such purposes may be formed by assembling the sample device 530 and the sample device lid 510. In some instances, the sample device 530 may be the same as or substantially similar to sample device 200, and the lid 510 may be the same as or substantially similar to the lid 400.

Further in FIG. 6, second part 455 and support part 475 forms an angle “θ1” equal or substantially equal to an angle “θ2” formed by the intersection of first part 460 and support part 475. In various embodiments, θ1 and θ2 are equal, or approximately equal to 90°. Moreover, as illustrated, the width w1 (or thickness) of first part 460 at root 790 can decrease to a second width w2 (or thickness) at base 491 (i.e., the first part 460 can taper from a larger width to a smaller width at the base 491). In various embodiments, the width w1 decreases linearly to width w2. In various embodiments, the width w2 can be one-half width w1. In various embodiments, the width w1 can be reduced linearly to width w2 that is one-half the width w1. In various embodiments, first part 460 can have a length l1, and locking lip 470 can have a length l2 that is less than l1. In various embodiments, l2 is approximately one-sixth of length l1.

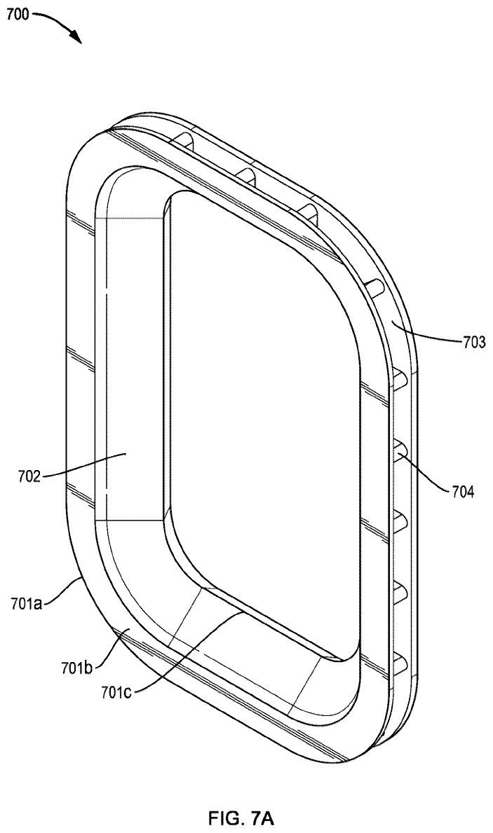

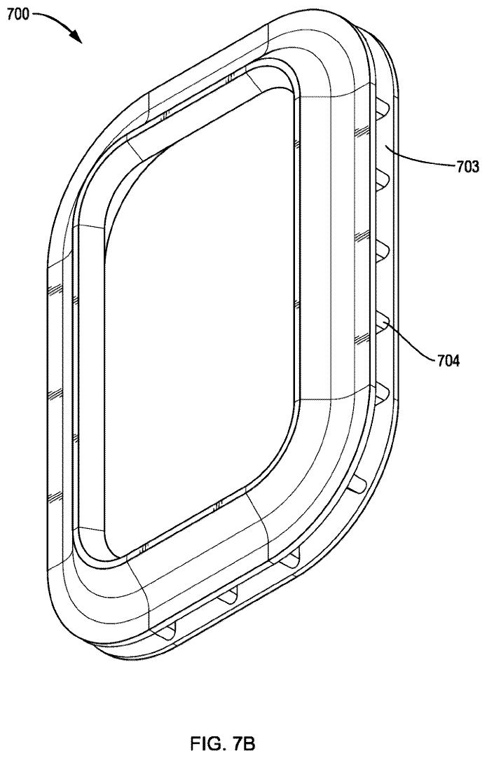

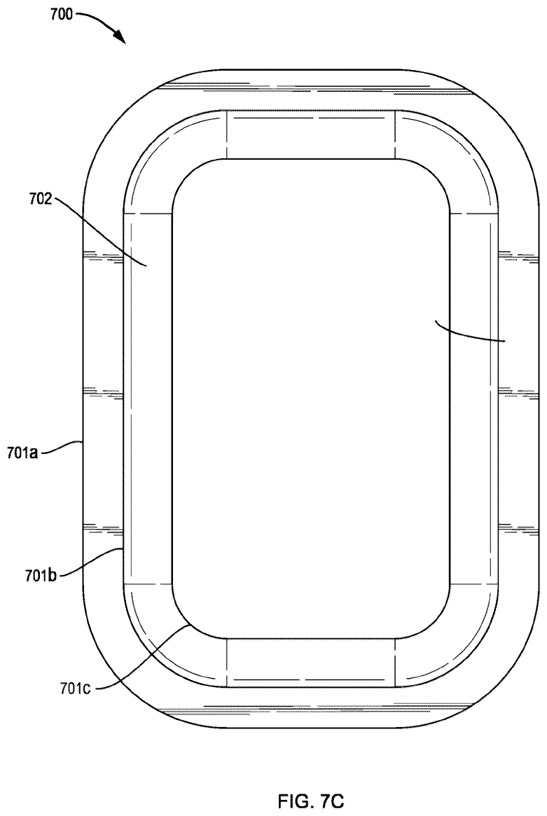

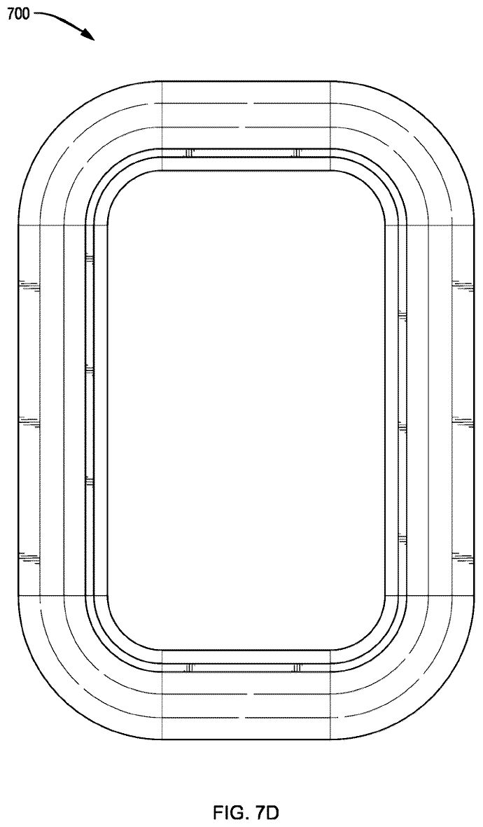

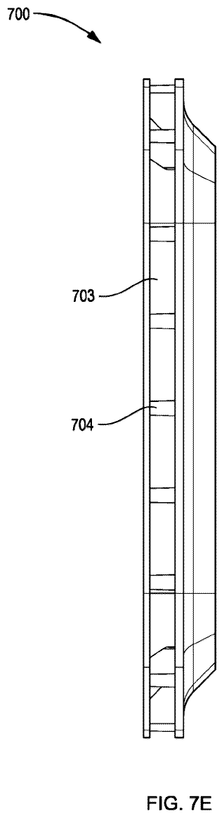

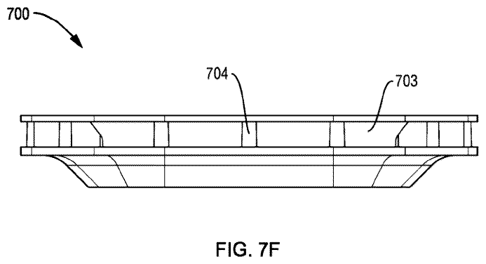

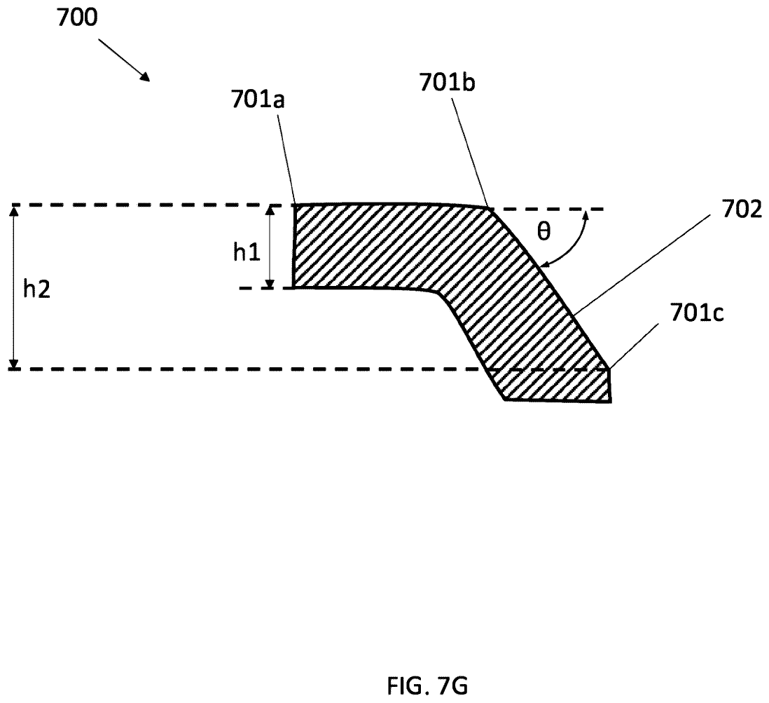

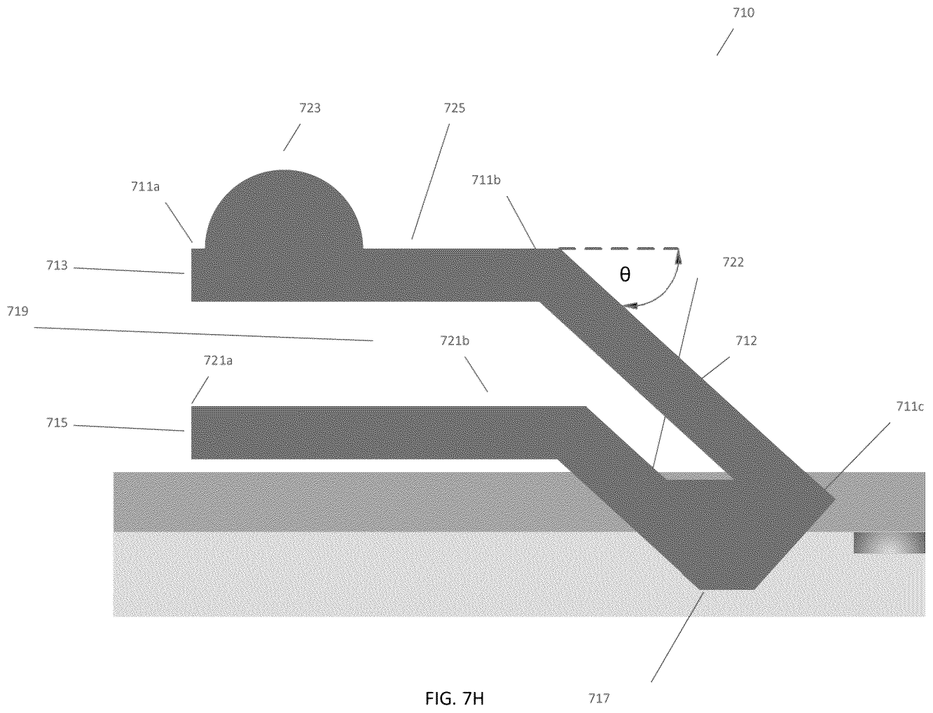

FIGS. 7A-7H illustrate a gasket for a sample device according to embodiments of the present disclosure.

FIGS. 7A-7G illustrate a gasket 700 for a sample device 200. As shown in FIGS. 7A-7G, the gasket 700 includes a substantially flat surface defined between a first perimeter 701a and a second perimeter 701b. In various embodiments, the gasket 700 includes a tapered portion 702 between second perimeter 701b and a third perimeter 701c. In various embodiments, the tapered portion 702 has a constant taper. In various embodiments, the tapered portion 702 has a variable taper (e.g., curved taper). In various embodiments, first perimeter 701a has a first width, second perimeter 701b has a second width that is less than the first width, and third perimeter 701c has a third width that is less than the second width. FIG. 7G illustrates a cross-section of the gasket 700 where the gasket 700 includes a height h1 (e.g., a thickness) for an upper portion that is substantially flat. In various embodiments, the upper portion includes a gap 703. In various embodiments, the gasket 700 includes one or more vertical ribs 704 disposed within the gap 703. In various embodiments, the tapered portion 702 is tapered over a height h2 and has an angle θ with respect to a horizontal axis. In various embodiments, the angle θ corresponds to (e.g., is equal to) an angle of an exterior of an objective lens to optimize the travel distance of the objective lens and thereby maximize the possible imaging area within the cassette.

FIG. 7H illustrates a cross section of an example gasket device 710 for a sample device 200, in accordance with various embodiments. Gasket 710 can include a substantially flat surface defined between a first perimeter 711a and a second perimeter 711b. In various embodiments, the gasket 710 includes a tapered portion 712 between second perimeter 711b and a third perimeter 711c. In various embodiments, the tapered portion 712 has a constant taper. In various embodiments, the tapered portion 712 has a variable taper (e.g., curved taper). In various embodiments, first perimeter 711a has a first width, second perimeter 711b has a second width that is less than the first width, and third perimeter 711c has a third width that is less than the second width. First perimeter 711a, second perimeter 711b, tapered portion 712, and third perimeter 711c together form an upper portion 713 that merges with a lower portion 715 about a base portion 717.

As illustrated, for example, in FIG. 7H, the upper portion 713 and lower portion 715 together form a gap 719. FIG. 7H also illustrates that lower portion 715 can include a fourth perimeter 721a having a first width, a fifth perimeter 721b having a second width, and a tapered portion 722. Tapered portion 722 can have a constant taper. In various embodiments, tapered portion 722 can have a variable taper (e.g., curved taper). In various embodiments, the slope (or angle θ with respect to a horizontal axis) of tapered portion 722 is the same, or substantially similar, to tapered portion 712. Similarly, in various embodiments, lower portion 715 can be co-planar to upper portion 713.

FIG. 7H further illustrates that upper portion 713 can further include an o-ring 723. O-ring 723 can be configured to extend from an upper surface 725 of upper portion 713. O-ring may sit along any portion of surface 725. FIG. 4H, for example, illustrates o-ring 723 positioned closer to first perimeter 711a than second perimeter 711b. O-ring 723 can be configured to extend from upper surface 725 and along the entire, or along substantially the entire, perimeter of gasket 700.

While the present teachings are described in conjunction with various embodiments, it is not intended that the present teachings be limited to such various embodiments. On the contrary, the present teachings encompass various alternatives, modifications, and equivalents, as will be appreciated by those of skill in the art.

In describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

What is claimed is:

1. An assembly, comprising:
a sample device including a bottom portion and a top portion, wherein:
the bottom portion is releasably coupled to the top portion;
a gap is formed between the bottom portion and the top portion when the bottom portion is coupled to the top portion, the gap configured to receive a sample substrate; and
the top portion includes a well and a plurality of first snap joint elements, at least a pair of the plurality of first snap joint elements arranged on the top portion substantially opposite from each other; and
a lid including a cover and a skirt, wherein:
the cover includes:
a planar outer surface; and
an inner surface separated from the planar outer surface by a thickness of the cover; and
the skirt extends about a perimeter of the inner surface, wherein:
the skirt and the inner surface define a recess;
the skirt includes a plurality of second snap joint elements extending therefrom, at least a pair of the plurality of second snap joint elements arranged on the skirt substantially opposite from each other, wherein:
when the lid engages with the sample device, the plurality of first snap joint elements engage with the plurality of second snap joint elements respectively to form a seal between the lid and a periphery of the well of the top portion.

2. The assembly of claim 1, further comprising a gasket disposed around the periphery of the well, wherein when the lid engages with the sample device, the gasket couples with a periphery of the skirt to form the seal.

3. The assembly of claim 2, wherein the well is defined by the sample substrate and the gasket.

4. The assembly of claim 2, wherein the well is a sealed chamber defined by the sample substrate, the gasket, and the lid. The assembly of any of claim 2, wherein the gasket includes an angled inner surface.

6. The assembly of claim 1, wherein one of the plurality of second snap joint elements includes a cantilevered clip and one of the plurality of first snap joint elements includes an aperture or a recess configured to receive the cantilevered clip when the lid is engaged with the sample device.

7. The assembly of claim 1, wherein the skirt extends about the perimeter of the inner surface at an angle that is greater than 90°.

8. The assembly of claim 1, wherein the skirt has a flange that is parallel to the planar outer surface.

9. The assembly of claim 8, wherein one of the plurality of second snap joint elements has a support section and a tab portion, the support section extending from the flange and having same thickness as the flange. The assembly of claim 9, wherein the tab portion includes a first part and a second part that are angled at less than 90° and at greater than 90°, respectively, relative to the flange.

11. The assembly of claim 10, wherein the first part is angled at greater than about 75° relative to the flange.

12. The assembly of claim 9, wherein the first part of the tab portion includes a locking lip at an end of the first part that is distal to the support section, the locking lip extending towards the cover.

13. The assembly of claim 9, wherein the second part of the tab portion includes a nob at an end of the second part that is distal to the support section, the nob extending away from the cover.

14. The assembly of claim 1, wherein the plurality of second snap joint elements include three cantilevered clips, two of which are located on one side of the skirt and the other of which is located on an opposite side of the skirt.

15. The assembly of claim 1, wherein the lid is formed using injection molding.

16. The assembly of claim 1, wherein the lid is made from a polyphenylsulfone material.

17. The assembly of claim 1, wherein the lid is made from a polyethylene material, a polyurethane material, a polyethylene terephthalate material, a polystyrene material, a polycarbonate material, a polypropylene material, or a combination thereof.

18. The assembly of claim 1, wherein the sample substrate is a glass slide.
